(19) United States
(12) Patent Application Publication
(10) Pub. No.: US 2007/0145063 A1
(43) Pub. Date: Jun. 28, 2007

(54) Disposable Bag Dispenser Attachment For Powered Vacuums

(76) Inventor: David Kaczmarek, Depew, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/426,483

(22) Filed: Jun. 26, 2006

Related U.S. Application Data
(60) Provisional application No. 60/693,742, filed on Jun. 24, 2005.

(51) Int. Cl. B65H 1/00; G07F 11/00; B65G 59/00

(52) U.S. Cl. 221/63; 221/199

(57) ABSTRACT

A disposable bag dispenser attachment for a powered yard vacuum having a main body with one end designed to attach to various yard vacuums. A canister attached to the main body is loaded with a pre-packaged, undetermined length and width of plastic bag tube. The tube bag is fed through an opening on the canister top and through the attached tube bag stop when in the open position. The tube bag is pulled from the canister and then the bag stop is closed. Next, the loose end of the bag is tied in a knot and the vacuum is operated. When the bag is full, the opposite end is torn off and tied in a knot and the bag is discarded. In order to fill another bag, the bag stop is loosened and another length of bag tube is fed from the canister.

### CROSS-REFERENCE TO RELATED APPLICATIONS

This application claims benefit of U.S. provisional patent application Ser. No. 60/693,742, filed Jun. 24, 2005, and entitled “Disposable Bag Dispenser Attachment for Powered Vacuums,” which is incorporated herein by reference.

### FIELD OF THE INVENTION

The present invention relates generally to lawn and garden products and specifically to an attachment for a yard debris collecting vacuum.

### BRIEF DESCRIPTION OF THE DRAWINGS

The invention is illustrated in the drawings in which like reference characters designate the same or similar parts throughout the figures of which:

FIG. 1 is a perspective view of the disposable bag dispenser attachment of the present invention attached to a powered yard vacuum unit;

FIG. 2 is a perspective view of the disposable bag dispenser attachment of the present invention;

FIG. 3 is a cross-sectional view taken along lines 3-3 of FIG. 2;

FIG. 4 is a partially cutaway perspective view of the tubular bag refill; and,

FIG. 5 is a detailed view of the tubular bag of the present invention.

### DETAILED DESCRIPTION OF THE INVENTION

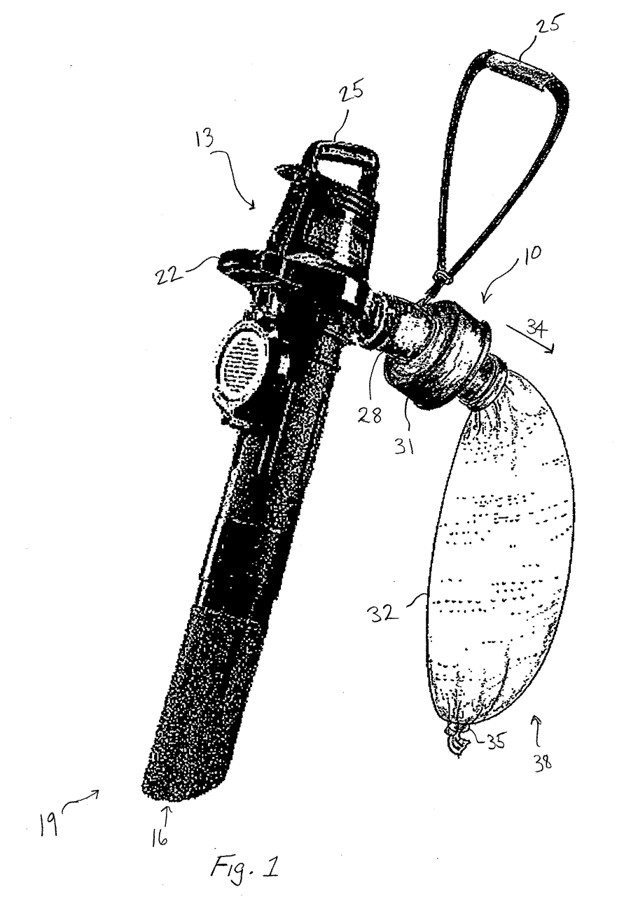

Referring to FIG. 1, the disposable bag dispenser attachment 10 of the present invention is attached to the outlet of a powered yard vacuum unit 13. The attachment 10 is designed to replace the re-usable fabric debris bag that is provided as standard equipment with yard vacuum unit 13. The yard vacuum unit 13 includes an inlet 16 disposed at a distal end 19 of the unit 13. The unit 13 also typically includes a first handle 22 and a second handle 25 for use by the operator. The attachment 10 has an adaptor 28 that engages with the debris outlet on the yard vacuum unit 13. The adapter 28 may be designed to fit with any commercially available vacuum unit 13 as will be evident to those of ordinary skill in the art based on this disclosure. The attachment 10 also includes a canister 31 for holding a supply of tubular flexible packaging. The flexible packaging 32 is capable of being stored in a tubular configuration and paid out of the canister 31 in the axial direction indicated by arrow 34 in FIG. 1.

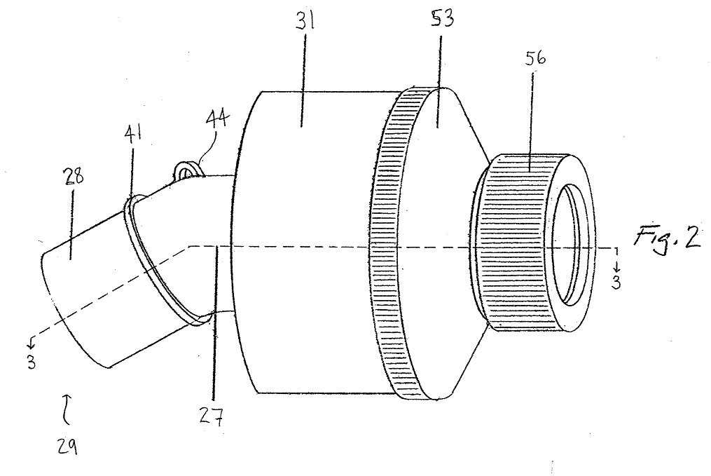

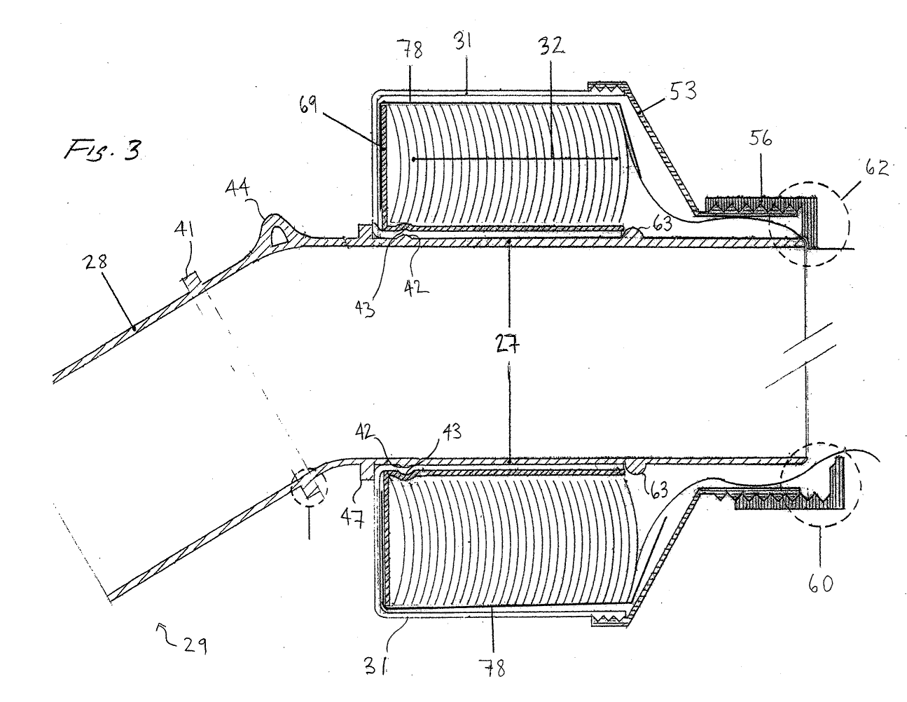

As shown in FIG. 1, the flexible packaging 32 can be tied in a knot 35 at a distal end 38 to form a disposable bag as will be described in greater detail herein. Turning to FIGS. 2 and 3, main body 27 has an adapter 28 at a first end 29. The adapter 28 is sized to mate with the debris outlet of the yard vacuum unit 13. A stop ring 41 may be provided to limit the distance that the adapter 28 will travel into the yard vacuum debris outlet. The main body 27 may be provided with an eyelet 44 for receiving a strap or handle.

The canister 31 is annular shaped and fits over the main body 27. The canister 31 may be positioned on the main body 27 by frictional engagement with stops 47 or cooperation of protuberances 42 and recesses 43 on the surfaces of the main body 27 and canister 31.

The canister 31 is a hollow annular body capable of receiving a ring-shaped supply of flexible packaging 32. The canister has an inside diameter sized to fit over the main body as shown in FIG. 3 and described previously. The canister 31 is provided with a canister cover 53 that may be provided with a threaded surface for removable engagement with the top of the canister 31. The cover 53 has a threaded opening at the top to receive the tube bag stop ring 56 as described below. In order to refill the canister 31 with a supply of flexible packaging 32, the cover 53 is removed and the packaging is inserted into the canister 31.

The tube bag stop ring 56 is a threaded circular cap that is screwed onto the top opening of the canister cover 53. When the stop ring is rotated counterclockwise to loosen the stop ring as shown in the detail section indicated by reference number 60, the tube bags inside the canister 31 are free to be pulled outward along the axial direction. When the stop ring 56 is rotated clockwise to tighten the stop ring at the top of the cover, as shown in the detail section indicated by reference number 62, the tube bags are pinched between the tube bag stop ring 56 and the canister cover 53 preventing the tube bags from being dispensed.

A canister stop ring 63 may be positioned around the periphery of the main body 27 to stop the canister 31 in the desired position and to keep the tube bag refill in position. Protuberances 42 also extend around the entire periphery of the main body 27 and keep the canister 31 locked in position relative to the main body 27 and also assist in keeping the tube bag refill in position inside the canister 31.

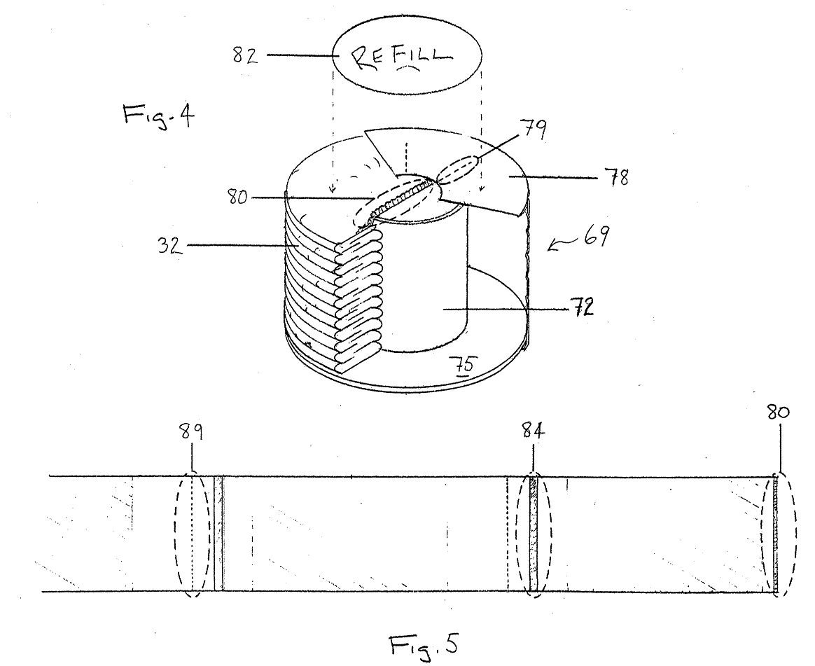

Turning to FIGS. 4 and 5, the flexible packaging 32 may be provided on a spool 69 having a core 72 and a bottom wall 75. The flexible packaging 32 is folded such that a significant length of packaging can be stored. The flexible packaging 32 may be held in position on the spool by a plastic covering 78 such as a heavy shrink wrap type material. The packaging exits the top of the spool in a single direction through a perforated opening 79 in the plastic covering 78. The opening may be covered by a label 82 prior to use.

The flexible packaging 32 is supplied as a continuous tube bag with tear off perforations 89 (FIG. 5.) The perforations also to allow air from the yard vacuum unit 13 to escape.

The initial section of flexible packaging is sealed shut at the end with a factory weld 80. After the first disposable bag is filled, the remaining bags are manually tied at the top and bottom by the user. As shown in FIG. 5, a printed stripe 84 can be used to indicate the position when the user should stop extracting the hollow tube bag from the canister. When the stripe is visible, the tube bag stop ring 56 is tightened to prevent further extraction of the tube bag. The printed stripe may be positioned approximately three to four inches away from the tear off perforations.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A disposable bag dispenser attachment for a yard vacuum having a debris outlet, the disposable bag dispenser attachment comprising:
a tubular body having a first end and a second end, the first end capable of attaching to the debris outlet of the yard vacuum;
an annular shaped canister having a central opening, the canister disposed around the tubular body such that the tubular body passes through the central opening;
a supply of folded flexible packaging disposed inside the canister, the folded flexible packaging capable of being paid out in the shape of a hollow tube such that flexible packaging can be tied off at an end to form a receptacle for receiving debris passing through the second end of the tubular body; and,
a stop capable of preventing the flexible packaging from being paid out.

2. The disposable bag dispenser attachment of claim 1, wherein the canister has a bottom wall at a first end and has side walls defining an opening at a second end.

3. The disposable bag dispenser attachment of claim 2, further comprising a canister cover having a first end and a second end, the first end capable of attaching to the second end of the canister.

4. The disposable bag dispenser attachment of claim 3, wherein the second end of the canister cover is disposed near the second end of the tubular body when the canister cover is attached to the canister.

5. The disposable bag dispenser attachment of claim 4, further comprising a stop ring capable of being attached to the second end of the canister cover such that the flexible packaging is pinched between the canister cover and the second end of the tubular body so that the stop ring can prevent the flexible packaging from being paid out of the canister.

6. The disposable bag dispenser attachment of claim 1, wherein the tubular body has at least one protuberance capable of engaging with the canister to position the canister relative to the tubular body.

7. The disposable bag dispenser attachment of claim 6, wherein the at least one protuberance engages with a groove in the canister.

8. The disposable bag dispenser attachment of claim 1, wherein the tubular body has an eyelet disposed thereon.

9. The disposable bag dispenser attachment of claim 1, wherein the tubular body has a ring disposed thereon at the first end to limit the distance that the first end of the tubular body will travel into the debris outlet.

10. A disposable bag dispenser attachment, comprising:
a tubular body having a first end and a second end, the first end having an adapter disposed thereon;
an annular-shaped canister disposed around the tubular body;
a canister cover removably attached to the canister, the canister cover having a first end and a second end, the second end of the canister cover being disposed adjacent to the second end of the tubular body when the canister is disposed around the tubular body;
a supply of flexible packaging disposed in the canister, the flexible packaging capable of being paid out between the canister cover and the tubular body, the flexible packaging capable of being paid out in the form of a tube; and,
an adjustable stop ring having a first end and a second end, the second end capable of moving in a first direction toward the second end of the tubular body to hold the flexible packaging in a fixed position between the second end of the stop ring and the second end of the tubular body, the second end capable of moving in a second direction in spaced apart relation to the second end of the tubular body such that the flexible packaging is free to be dispensed.

11. The disposable bag dispenser attachment of claim 10, wherein the tubular body has at least one protuberance capable of engaging with the canister to position the canister relative to the tubular body.

12. The disposable bag dispenser attachment of claim 11, wherein the at least one protuberance engages with a groove in the canister.

13. The disposable bag dispenser attachment of claim 10, wherein the tubular body has an eyelet disposed thereon.

14. The disposable bag dispenser attachment of claim 10, wherein the tubular body has a ring disposed thereon at the first end to limit the distance that the first end of the tubular body will travel into the debris outlet.

15. A yard debris collecting device, comprising:
a vacuum unit having an elongate hollow body with an inlet at a distal end and a debris outlet and at least one handle at the proximal end;
a tubular body having a first end and a second end, the first end capable of attaching to the debris outlet of the yard vacuum;
an annular shaped canister having a central opening, the canister disposed around the tubular body such that the tubular body passes through the central opening;
a supply of folded flexible packaging disposed inside the canister, the folded flexible packaging capable of being paid out in the shape of a hollow tube such that flexible packaging can be tied off at an end to form a receptacle for receiving debris passing through the second end of the tubular body; and,
a stop capable of preventing the flexible packaging from being paid out.

16. The disposable bag dispenser attachment of claim 15, wherein the canister has a bottom wall at a first end and has side walls defining an opening at a second end.

17. The disposable bag dispenser attachment of claim 16, further comprising a canister cover having a first end and a second end, the first end capable of attaching to the second end of the canister.

18. The disposable bag dispenser attachment of claim 17, wherein the second end of the canister cover is disposed near the second end of the tubular body when the canister cover is attached to the canister.

19. The disposable bag dispenser attachment of claim 18, further comprising a stop ring capable of being attached to the second end of the canister cover such that the flexible packaging is pinched between the canister cover and the second end of the tubular body so that the stop ring can prevent the flexible packaging from being paid out of the canister.

20. The disposable bag dispenser attachment of claim 15, wherein the tubular body has at least one protuberance capable of engaging with the canister to position the canister relative to the tubular body.

21. The disposable bag dispenser attachment of claim 20, wherein the at least one protuberance engages with a groove in the canister.

22. The disposable bag dispenser attachment of claim 15, wherein the tubular body has an eyelet disposed thereon.

23. The disposable bag dispenser attachment of claim 15, wherein the tubular body has a ring disposed thereon at the first end to limit the distance that the first end of the tubular body will travel into the debris outlet.
